(19) United States
(12) Patent Application Publication
(10) Pub. No.: US 2005/0165738 A1
(43) Pub. Date: Jul. 28, 2005

(54) Providing location dependent information

(75) Inventor: Paul Damon Lancefield, Wilbeldon (GB)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Infinite Reason Ltd., West Wimbledon, London (GB)

(21) Appl. No.: 10/508,733

(22) PCT Filed: Mar. 21, 2003
(86) PCT No.: PCT/GB03/01229

(30) Foreign Application Priority Data
Mar. 21, 2002 (GB) 0206703.1

(51) Int. Cl. G06F 17/30

(52) U.S. Cl. 707/3

(57) ABSTRACT

A geographic information system for operation with an accreditation database storing identities of information providers and indications of whether each of those information providers is a member of an accreditation group, the system comprising a geographic information database for storing a list of information sources external to the database together with, for each source, the identity of an information provider associated with the source and one or more geographic definitions associated with the source, a search unit for receiving from a user an indication of a geographic location, accessing the geographic information database to form a set of information sources whose geographic definitions encompass that location and associated with an information provider that is indicated by the accreditation database as being a member of one or more predetermined accreditation groups, and making that set of information sources available to the user.

This invention relates to providing a user with information relevant to his current locale. For example, when the user has a data terminal at his current locale he may wish to be provided with access to information sources relevant to that locale. In doing so he is likely to want to minimise irrelevant or “junk” information which unscrupulous information providers may attempt to provide to him.

Geographic information systems (GISs) have been developed, primarily for business, industrial or academic applications. Such GIS systems allow the entry or retrieval of data to or from a central database by means of a portable terminal. The systems are generally capable of determining the location of the terminal, and are arranged to perform certain operations automatically, when data is to be entered or retrieved, in dependence on the determined location. Current GIS applications are generally specialist and complex, and when they are used in the field they tend to focus on data gathering rather than data retrieval. Where they do cater for data retrieval the data is usually retrieved from a centrally managed database and is for industrial application. Currently the most widely available consumer oriented GIS applications cater for the route planning market.

In the future it can be expected that as wireless compatible PDAs (personal digital assistants) and other mobile data terminals become more common, as do GPS (Global Positioning System) systems including portable GPS and in-car GPS technology, there will be an increasing demand for geospatial database services for the general consumer market. Once personal computer (e.g. PDA) hardware is available with GPS or other location-determining capability at the right price, it can be expected there will be an increased demand for general information pertaining to the user's current location. However there are considerable difficulties that need to be overcome if a wide range of general information from a diversity of information providers is to be made available to the consumer.

For such a general geographic information system to be useful it must contain a comprehensive set of information, and for the system to find common acceptance it should consistently operate where users commonly travel with a need or desire to access information. Compiling a sufficient depth of information on a system to allow complete locale-based searching would be a difficult, if not impossible, undertaking for any single legal entity or organisation. It would therefore be advantageous if individuals or organisations with existing network based information relevant to a given locale, whether retail information (e.g. a web home page for a branch of a shop), historical (e.g. the home page for a place of historical interest like Dover Castle) or one of the many other kinds, were able to provide their information such that it could be easily accessed by the end user based on his or her current location. Such information could typically be in the form of world-wide web (WWW) pages, but other forms of data could also be included.

One solution would be to establish a standardised directory service, in which information providers could publish information indexed with location information, together with an information access system where consumers can retrieve information sources related to a given location from the directory. However this solution is open to abuse. If such a directory service were available and open to update by information providers in an unrestricted fashion, there is then the problem that the system would be flooded with irrelevant information. Unscrupulous information providers would wish to provide information relating to locations of popular interest simply because they are interested in users of the database obtaining output directing the user to their own preferred information sources and not because those information sources are actually likely to be found to be relevant by a user at that place. There is thus a risk that they would enter into the database that their data was relevant to locations for which it was of no or of marginal relevance, with the aim of drawing the data to the attention of users at those locations. This would make the data produced by the system unreliable, since users could not be confident that the data retrieved for a certain locale was relevant. There is also the risk that such a service could be rendered unusable through information providers entering irrelevant information en masse and overloading the database.

One technical means to reduce the problems of unscrupulous information providers indicating their data as being relevant to locations for which it is of little or no relevance would be to provide a mechanism whereby users of the system can elect to receive data only from trustworthy information providers. These could be information providers who have been identified as operating with sufficient respect for the requirements of the system. However here again there is a problem. It is difficult if not impossible for users to know in advance what kind of information providers might provide useful information sources to them for the location they are currently visiting or have an interest in. This is especially true if a user has not visited the location before.

There is therefore a need for a system that allows an easy mechanism for information providers to post references to geographically relevant information sources, but which can implement a means for a user to, receive only relevant information and so help to filter out information posted by less scrupulous providers.

According to one aspect of the present invention there is provided a geographic information system for operation with an accreditation database storing identities of information providers and indications of whether each of those information providers is a member of an accreditation group, the system comprising: a geographic information database for storing a list of information sources external to the database together with, for each source, the identity of an information provider associated with the source and one or more geographic definitions associated with the source; a search unit for receiving from a user an indication of a geographic location, accessing the geographic information database to form a set of information sources whose geographic definitions encompass that location and associated with an information provider that is indicated by the accreditation database as being a member of one or more predetermined accreditation groups, and making that set of information sources available to the user.

According to a second aspect of the present invention there is provided a method for providing geographic information to a user, in a system capable of operating with an accreditation database storing identities of information providers and indications of whether each of those information providers is a member of an accreditation group, the method comprising: storing in a geographic information database a list of information sources external to the database together with, for each source, the identity of an information provider associated with the source and one or more geographic definitions associated with the source; receiving from a user an indication of a geographic location; accessing the geographic information database to form a set of information sources whose geographic definitions encompass that location and associated with an information provider that is indicated by the accreditation database as being a member of one or more predetermined accreditation groups; and making that set of information sources available to the user.

Preferably the system comprises a user database for storing for each user a set of accreditation groups, and wherein the said predetermined accreditation groups are the accreditation groups stored for the user in the user database. The user database may also store for each user one or more identities of information providers for which the user wishes information sources to be made available to him irrespective of their, membership of any accreditation groups.

The set of information is conveniently made available to the user by being transmitted to the user. Alternatively, the user may be permitted to browse the set.

The accreditation database is preferably a publicly accessible database. The database preferably indicates the membership of a number of accreditation groups by indicating which information providers are members of which entities (information providers etc.) are members of which of those groups. The appearance of an entity In at least some of the groups is preferably subject to the authorisation of an accreditation body such as a professional or trade organisation.

The system may comprise an input unit whereby an indicating user may provide an information source and one or more geographic definitions associated with the source for storage in the geographic database. The input unit may accept input from the indicating user, process that input to determine whether it may be accepted into the database and if acceptable, provide the information to the database for storage.

The input unit may be arranged to cause the identity of the said indicating user to be associated with the indicated information source as the identity of the information provider. The indicating user may be authenticated by means of the accreditation database.

The input unit may be arranged to limit the capability of an indicating user to provide a geographic definition for storage in the geographic database in dependence on the accreditation groups of which that indicating user is indicated in the accreditation database as being a member. Preferably the input unit includes one or more definitions of limitations that are to be applied in dependence on which groups the indicating user is a member of. Such limitations could include limits for the geographic scope (e.g. area, volume, population coverage) of the geographic definitions that the indicating user may provide for storage in the geographic database; limits on whether the geographic definitions that the indicating user may provide to the database may or may not overlap or fall within geographic definitions already stored in the database. Those geographic definitions already stored in the database are preferably geographic definitions that are stored with association to one or more information provider who are members of at least one group in common with the indicating user.

The input unit may be arranged to limit the capability of an indicating user to provide one or more information sources for storage in the geographic database in dependence on the accreditation groups of which that indicating user is indicated in the accreditation database as being a member. Preferably, it is arranged to limit the number of such sources that can be stored, depending on which groups the indicating user is a member of.

The search unit is preferably arranged to include in the said set of information sources information sources whose geographic definitions encompass that location which are associated with an information provider specified by the user.

The user may interact with the search unit by means of a data terminal. The terminal is preferably portable. The terminal may be a PDA. The terminal is preferably capable of determining its location, for example by means of the GPS system or by means of a cellular telephone system.

The geographic database and the search unit are preferably at the same location. The accreditation database is preferably remote from the geographic database. The accreditation database is preferably linked to the search unit by means of a publicly accessible network such as the internet. The user is preferably capable of communicating with the search unit by means of a publicly accessible network such as the internet.

The present invention will now be described by way of example with reference to the accompanying drawings.

In the drawings:

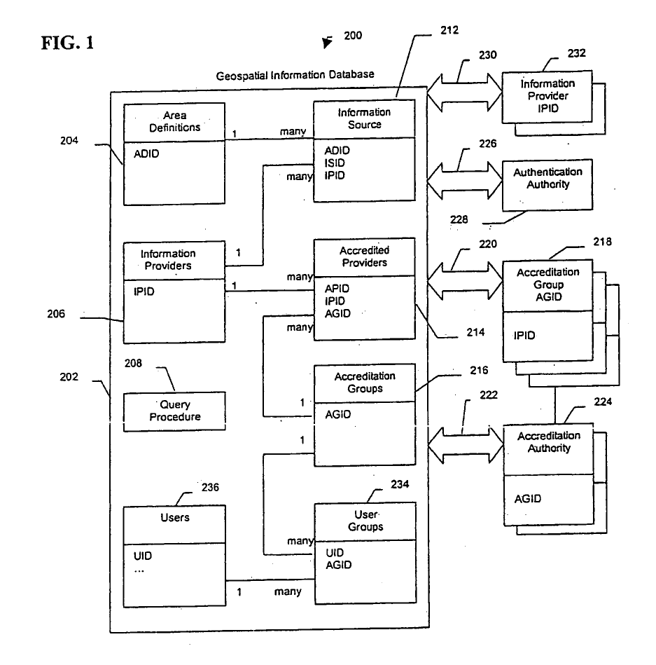

FIG. 1 illustrates a system for providing location-dependant information to users;

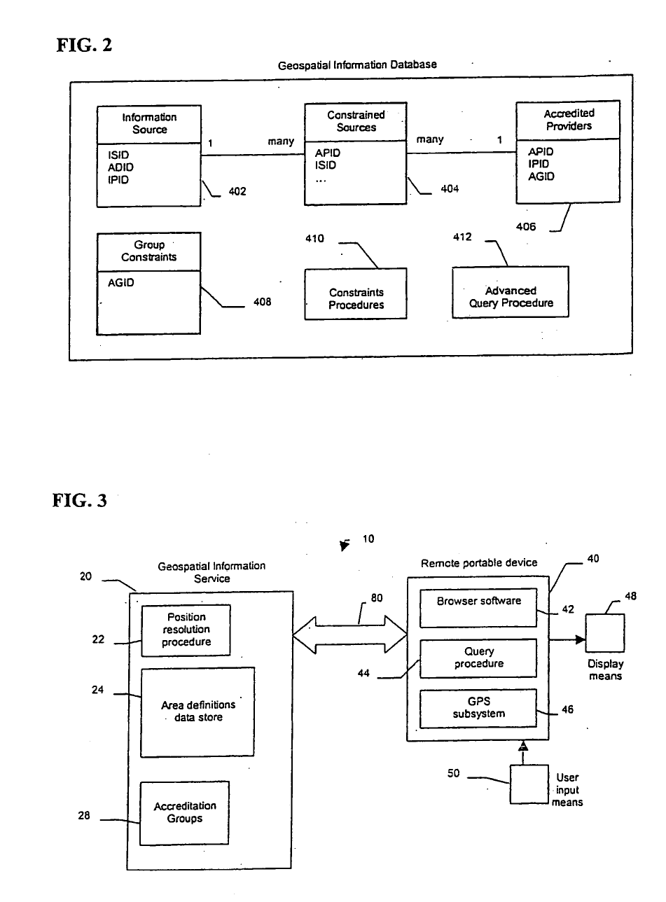

FIG. 2 illustrates database tables for constraining editorial privileges; and

FIG. 3 illustrates a system comprising a client device and a information service provider.

The present system will be described with reference to retrieving information from web sites. However, the system could be used with information from other sources, for example proprietary databases that are accessible over a network such as the internet.

The present system is capable of retrieving qualified references to an external web site containing information relevant to a given geographic position reference. In the preferred embodiment, a Geospatial Information Database (202) stores either 2-dimensional or 3-dimensional area definitions (204) which include sufficient information to define a point or zone relative to the actual surface of the earth. Each area definition is stored in respect of one or more sources of information. The sources of information could be web pages. The system provides an interface (230) to the database, which allows information providers to edit and update the area definitions in respect of information (e.g. web pages) provided by them. The exact means by which this is done is not essential to the invention but one convenient means would be through use of e.g. a bespoke downloadable application which allows the information provider to draw 2-dimensional or 3-dimensional outline shapes (area definitions) over a map or to select from pre-provided area definitions. Then the definitions are uploaded to the database so that those area definitions can be stored. The definitions could be stored as a precise global position, or as such a position together with a radius that defines a zone around the position, or as a set of such positions defining a zone between them. The information provider can further associate one or more information sources (212) (e.g. web pages) with the area definitions. The information sources may be identified in the database by means of their URLs (uniform resource locators). In this manner a web page stored outside the database can be associated with an area or locality.

The area definitions define geometric 2 dimensional or 3 dimensional shape, conveniently by means of vectors. The shape is fixed in location relative to the earth's surface as the earth rotates, such that it is always in the same position relative to the geographic features of the earth.

In order for the information provider to gain access to the system in order to add or modify a definition or its link with an information source, it is preferred that his identity is first authenticated. Authentication could be performed by an application of the database, but in the preferred embodiment the database utilises a standard form of devolved Authentication Authority service (228) such as (e.g. Microsoft Passport).

The information provider (who is treated as a user of the system for the present description) accesses the database and if the user is not already logged-on to the external Authentication Authority account the user is redirected to the sign-in web page hosted and managed by the authority. If the user is already logged in, or (if the user is not logged in) once the user has logged in to the authorities service; the authority sends the user's identity to the database service encrypted with the database services public key via a public network or direct communications link (226). The database service decrypts the user identification, extracts the user ID and can then use the ID key to verify the user has an account on the system and allow (or disallow if no account exists or the account has been suspended) the user to access the service.

Using an external authority for authentication offers the advantage that information providers are able to gain access to the system with a widely usable identity that is under their control. Such an identity may be used by other systems than the database (202). This is advantageous because it means that identity (ID) can also be utilised by an external Accreditation Authority (224) and may be listed on an accreditation group (218) by the authority. Technically, an accreditation group is simply a list of identities stored under a group identity associated with the ID of a person or organisation which can itself be authenticated or certified. (One example of such a system which is expected soon to gain popularity is the Microsoft UDDI Business Registry).

The database keeps a record of the identities of information providers who have provided information to the system, so that when those information providers subsequently authenticate themselves they can be permitted to modify the data they stored in the database. As well as tracking information providers known to the system (206) in this way, the database also replicates the accreditation groups (214) on the database (216) found external to the database (218) and which would typically be hosted by the Accreditation Authority. Each accreditation group is linked to one or more information providers and information providers may be members of one or more accreditation groups.

A user may be known to the database, in which case the database stores a record of the user (236), or unknown to the database, in which case no record for the user is stored on the database. A list of accreditation groups can be associated with a user through use of the User Groups table (234). In the preferred embodiment this is used to keep a record of each known user's preferred accreditation groups.

Accreditation groups have an important “social” role in the operation of the system. They are used together with some form of manual inspection or accreditation procedure, to group and label information providers matching certain standards of responsible behaviour. Professional or commercial trade bodies could provide accreditation groups for their members. For example, qualified doctors are clear candidates for inclusion in such groups, and bodies such as the British Medical Association could provide an authenticated listing of all qualified doctors together with their certified identities according to the emerging standards. Consumer organisations such as the Consumers' Association could certify lists of organisations that meet certain trading standards and other standards of conduct. In a simpler system accreditation groups could be derived from published lists of members of professional or commercial trade bodies.

The UDDI (universal description, discovery, and integration) business registry provides a method for organisations to publish accreditation information according to a common standard described by the UDDI specification, the Microsoft My Services Lists specification and/or the Microsoft My Services Groups specification. The UDDI registry is itself an XML (extensible mark-up language) web service and uses SOAP (simple object access protocol) over HTTP as its messaging protocol to ensure open standards. These services make use of the NET framework, which is a collection of distributed web component technologies and services developed by Microsoft. It includes Net Services, which are publicly accessible services adhering to the SOAP protocol and published on a UDDI server. SOAP is a set of rules for how data types and commands should be presented such that diverse languages capable of supporting a base set of object based programming principles can interface with one another, regardless of the languages' own internal rules. Further, in an appropriate development environment, the attributes inherent to a SOAP model that are foreign to the user of a programming language can be entirely hidden from view.

It can also be expected that information providers that have been subject to some form of accreditation before being allowed to be members of an accreditation group would be more likely to take legal commitments seriously. Preferably all information provider organisations providing information to the database would be required to agree to legally binding usage rules and to a code of conduct. Alternatively, or in addition, there may be an operational unit associated with the geographic database itself, which maintains a list of responsible information providers and operates an assurance, procedure, ensuring any provider acting irresponsibly is removed from the group.

As described above, lists of accreditation groups and the members of those groups are available to the database. By this means the database can allow a user to limit the information providers from whom he is willing to receive information. When a user wishes to use the database to obtain location dependant information he can provide to the database a definition of the information providers from whom he is willing to receive information. One way in which this can be done is for the user to, select one or more individual information providers. In doing so the user can check whether those providers are members of any accreditation groups. This check can be made by means of the database itself or via another publisher of the accreditation groups using the UDDI specification. Another way in which the user can indicate the information providers from whom he is willing to receive information is to select one or more whole accreditation groups, as a result of which the database will offer the user relevant information from any information provider who is a member of those accreditation groups, without having to specify individual IDs.

The database includes a basic information source retrieval means, which is a query procedure (208) using a geographic position reference together with one or more Accreditation Group ID's as input. There are several forms such a query procedure can take. Two of the more useful forms are described here. The first (not the preferred embodiment) is the more basic of the two. The second, the preferred embodiment, is similar to the first, but is slightly modified and includes some extra tables (detailed below) and an extra step in the query.

The first basic query procedure can be broken down into the following steps.
1. A user who wishes to be presented: with location dependant information supplies a definition of his geographic position to the database. This could be done by the user entering his position directly and providing that information to the database, but it is preferred that the user's terminal equipment (for example his PDA) determines its location automatically (for instance by means of the GPS system or a cellular telephone system) and provides that location automatically to the database.
2. The system provides a means to retrieve area definitions through use of a geodesic query. Many forms of geodesic query exist, but the preferred form (also used in the more advanced query of the preferred embodiment) finds all area definitions for which the given geographic position reference falls within the boundary of the definition. Other types of query can be used.
3. Once the area definitions are returned all the information source references (URLs) associated with the area definitions are also returned and stored as a first result set. Each of these references is associated with the ID of the information provider who provided that reference in the database.
4. The system then goes on to execute a query against the list of IDs and accreditation groups that the user has indicated to the database that he is willing to receive data from in order to compile a list of those IDs together with the IDs of the information providers who are members of those groups. This list is stored as a second result set.
5. Finally the database creates a third result set made up of the information source references from the first set that are associated with an ID in the second set. This defines the set of references that have been indicated by information providers from whom the user is willing to receive data as being relevant to the user's location. In this way data from information providers from whom the user is not willing to receive information are excluded from this final result set.
6. The results are returned to the client by the database transmitting to the users terminal a list of the information source references in the third result set.

The location for which the search is performed need not be the current location of the user. The user could enter another location to find information about that location: for instance to find information about hotels at a remote location.

If the user has not provided the database with a list of information provider IDs and/or accreditation groups then the database may utilise a default set of IDs and/or accreditation groups for step 4.

It is preferable that the database can keep a record of user ID's (236) and store a list of accreditation groups associated with a given user (234). Finally if the user has set up a list of preferred accreditation groups a fourth result set is created by constraining the third result set to those user preferred groups. If the user is not known to the system either because he/she did not provide a user ID or because a user ID that was provided does not match any user ID stored on the system, a default set of preferred accreditation groups will be used.

The results are returned to the client portable device. Preferably, in addition to the information source references, the results returned to the client also include accreditation groups associated with the information providers that are associated with the information source references. In the preferred embodiment the information source references are grouped by accreditation group, the groupings being determined by the chain of associations.

The following is a sample fragment of such output:

<GROUP>Retailers</GROUP>:

<INFPROV>Dixons</INFPROV>

<INFSRC>Dixons Wimbledon</<INFSRC>

<INFPROV>W H Smith</INFPROV>

<INFSRC>W. H. Smith Wimbledon</INFSRC>

<GROUP>Public Transport</GROUP>

<INFPROV>Railtrack</INFPROV>

<INFSRC>Wimbledon Mainline Station</INFSRC>

<INFPROV>SE Trains</INFPROV>

<INFSRC>SE Trains at Wimbledon Mainline
Station</INFSRC>

It should be noted that the exact method by which the database determines if an information source reference is in the spatial locale of a geographic position reference is not essential to the invention. Provided the references are stored with information that is sufficient to provide a precise geographic location (e.g. better than 50 meters accuracy) and the search means can discover either information local to the user's current position reference (e.g. less than 2 kilometres) or area definitions local to the user's current position that are in turn related to information source references the system will provide benefit. There are many commercial GIS database product capable of storing data against a geographic location and resolving a query based on GPS or other data and differing methods by an appropriate result can be achieved.

Even with accreditation providing a mechanism to reduce abuse, the potential for damaging forms of abuse remains. If for example, there is an accreditation group for retailers, with all the major high-street names represented, there will always be the temptation for an individual retailer to define area definitions extending far beyond the area of the actual physical presence of his shop so as to encompass the geographical locations competing businesses. This would provide an advantage to the retailer in the form of an increased presence or profile before users of the system, but would undermine the system as a whole because users would not, in the main, be interested in being presented with information about such retailers at such ill-defined locations. The geographic nature of the service would be undermined.

A framework of legal agreements could be implemented to reduce the risk of such abuse but even with a legal framework in place it would be difficult to eradicate operator error, or reconcile all differences of interpretation or ensure against occasional abuse. Also, enforcing such agreements would be highly time-consuming. Unfortunately if information provider editorial rights are unrestricted, such abuse when it happens would damage the utility of the system. A wayward accredited retailer could, for example, define an area definition to cover the entire surface of the globe. Whenever a search is conducted including the accredited retailers group the wayward retailer could ensure a listing is always obtained in the results. However if an information provider is a member of an accredited group of geologists, it might be entirely legitimate to define extremely large area definitions, encompassing e.g. entire continents.

To address these problems in the preferred embodiment the geographical definitions that an information provider can enter into the database are constrained on the basis of the information provider's membership of accreditation groups. This provides an additional apparatus to help ensure the right balance can be struck between editorial freedom (which is required to stimulate information providers to register with the service) and the kind of constraints that is required to help preserve the geographic value of the service.

The system further allows information provider editorial privileges to be restricted in accordance with each of the accreditation groups that the provider is associated with, such that rules constraining what the information providers can enter on the system are defined on a group-by-group basis.

FIG. 2 shows two additional tables: constrained sources (404) and group constraints (408), which together with constraints procedures (410) and an advanced query procedure (412) provide the preferred means to implement this functionality. Some of the tables shown in FIG. 2 supersede those shown in FIG. 1. In the basic system described, the information provider may enter an unlimited number of area definitions and information sources on the database. However when querying the system the user will not see these in the results unless they are related to an information provider who is a member of an accreditation group related to the user (i.e. when the accreditation group is a user preference or, if the user has not expressed a preference, a user default). In the more advanced version of the system the information provider may still enter an unlimited number of area definitions and information source references; however the information provider can elect to relate information directly to an accreditation group. Any information source references so related are entered on an additional table, the constrained sources table (404). The constrained sources table is so named because a provider cannot assume it will be possible to relate just any number or any kind of information provider entries to an accreditation group using this table. Constraints procedures (410) are implemented to limit the quantity and quality of the information a provider is allowed to store on the table according to rules set out for the accreditation group in the group constraints table (408).

Accreditation group constraints include but are not limited to:
Size of area definition that can be entered
Number of area definitions allowed to be entered
Whether overlaps are allowed with existing area definitions
Whether area definitions associated with another specified provider group take precedence
Whether the provider is allowed to define his own area definitions or is forced to use pre-existing area definitions
Whether a moderator is required to validate edits made by an information provider prior to them being made live

The system administrator can implement different rules for limiting the type and attributes of an information source reference depending on the accreditation group the source is associated with such that e.g. the area definitions for information sources associated with a retailers accreditation group, could be limited to 1000 sq meters, only allowed where an existing area definition in the same group doesn't exist, or provided the information provider (presumably a retailer if so accredited) hasn't exceeded a maximum number of area definitions.

It is also required that an advanced query procedure (412) is implemented and used in place of the previously described query procedure. Now when a user or system requests information pertaining to a locale AND that is related to a one or more accreditation groups, the query retrieves only information source references (e.g. URL's) related to the locale, the information provider's associated with the given accreditation groups AND that are records on the constrained sources table.

The system described above provides a means whereby a geodesic query for references to external data sources of accredited information providers can be executed. In the system accreditation is devolved to third party authorities and the user or service operator can select which third party authorities qualify and constrain the results.

The system provides a means combining geodesic queries and public verifiable IDs and accreditation groups, for a person or system seeking general information pertaining to a locale to access a variety of information source references that are maintained and edited by independent parties, whilst achieving the important user goal of reducing the number of data sources browsed through constraining the list to information sources references to those provided by either the user's preferred accredited information providers or a default list of accredited information providers. The manner in which the system works means that the operator of the system supporting the query means will have additional leverage to motivate information providers to maintain their scruples and the quality of their listings.

The system provides a means for allowing a user or system to quickly and easily access pertinent local area information from a variety of publication sources. A user or system with an interest in a geographic location can find information registered by other users or organisations pertaining to that location. The system can also be used in conjunction with a business operation that qualifies information providers.

By means of the system the user of a client device with a means to procure its global position (e.g. through use of GPS) can obtain easy “one click” access to a list of relevant local information resources provided by a variety of information providers, wherever that user may be. Because the information resources are qualified through referencing. Only accredited information provider groups, the system allows the user to navigate fewer options whilst retaining confidence in the quality of the result-set.

The information sources listed are maintained by information providers independent of the geospatial database service and can be standard web pages that in most cases would have been created regardless of any additional user traffic generated by the geospatial database service. The information provider can obtain additional user traffic with minimal effort through registering with the service. Ease of registration will lead to a more comprehensive range of information being made available to the end, user. The ability for a user to specify accreditation groups makes the system customisable to any kind of user requirement, thus the design makes the database an excellent candidate for being the authoritative source of geographic information available on'the web.

Referring to FIG. 3, the user's terminal may be a portable client device (40) having a connected GPS receiver/decoder system (44) a software means for retrieving references to information sources pertaining to the local area from a Geospatial Information Database (20) via a (wireless) Internet connection (80) and a display means (48) for displaying the list of references once it is retrieved. The Geospatial Information Database may be as described above. In addition to the described server side functionality the user with the client device has a one click means to request a list of qualified information source references from the Geospatial Information Service.

The functioning of the Geospatial Information Database is described above.

In the preferred embodiment, the user of the client device has an account on the database and the user's preferred accreditation groups are stored against the user's ID. In an alternative embodiment, the user does not have an account on the database and has preferred accreditation groups that have been, at an earlier time, retrieved from the database and stored locally on the client device.

In addition to the described server-side functionality, which is provided at the Database (20), a user with the client device can conveniently be provided with a means (e.g. through selecting a single option on the portable device user interface) to request a list of qualified information source references from the Geospatial Information Service. The query has a number of, available implementations. In the preferred embodiment, the user may select in advance which implementation is to be the default implementation when the query is executed.

On choosing the option, the portable device:
1. Checks if a network connection providing access to the Geospatial Information Database is available. In the preferred embodiment if a network connection is not available the procedure may automatically establish a network connection.
2. Retrieves positioning information for the user's (i.e. the devices) current location from a GPS subsystem accessible to the portable device
3. Queries the Geospatial Information Database providing:
   (a) the User's ID;
   (b) position information indicative of the position of the client device as determined by its GPS unit;
   (c) optionally, if the user does not have an account on the database, the user's preferred accreditation groups or preferred information providers. In the preferred embodiment this step is not necessary because every user has an account with the database and the user's ID will provide sufficient information for the Database to look-up either the system default accreditation groups/information providers, or, if the user has edited the accreditation groups associated with his/her account, the user's preferred accreditation groups.

Then the Geospatial Information Database returns:
(a) A list of accreditation groups that are the user's preferred accreditation groups AND that are groups containing geographic information source references related to the current position information;
(b) The information source references that related to the current position information AND that have been provided by information providers that are members of the user's preferred information provider groups.

In alternative embodiments the database may also return:
(c) Information providers that have provided information source references related to the provided position information AND that are members of the users preferred accreditation groups.

Other alternative embodiments exist in which any one or more of (a), (b) and (c) above can be provided.

In the preferred embodiment the results are returned to the client device in the form, of a file (e.g. an XML file) which includes information sufficient to convey the data (a), (b) and/or (c). In alternative embodiments explicit relationship information may also be omitted and the relationships inferred by the natural order of the results, in which case a single information source reference may appear multiple times, if the information provider is a member of more than one of the users preferred accreditation groups, or if the information source is cited by more than one accredited information provider.

The following is an example of a fragment of such output:

<GROUP>Retailers</GROUP>:

<INFPROV>Dixons</INFPROV>

<INFSRC>Dixons Wimbledon</INFSRC>

<INFPROV>W H Smith</INFPROV>

<INFSRC>W. H. Smith Wimbledon</INFSRC>

<GROUP>Public Transport</GROUP>

<INFPROV>Railtrack</INFPROV>

<INFSRC>Wimbledon Mainline Station</INFSRC>

<INFPROV>SE Trains</INFPROV>

<INFSRC>SE Trains at Wimbledon Mainline
Station</INFSRC>

In the preferred embodiment the user may in advance select a default means of dealing with the results that is responsive to (i.e. automatically triggered on) receiving the results from the database. Examples of such means include:
1. Display a list of the information source references that have been returned on the portable device display unit. The user may select any information source reference to access the actual information source.
2. Display a list of the accreditation groups that have been returned on the visual device display unit. The user may select any accreditation group to obtain a list of information source references related to that accreditation group and, may subsequently select any information source reference to access the actual information source. This approach has the advantage of ensuring the user can most easily navigate easily through results for locations where many information source references are returned and allows browsing of information source references by type (as defined by the accreditation group).
3. Displays a list of information source references that have been returned on the portable device display unit grouped by accreditation groups that have been returned. This provides is a variation on the function provided by 1. above where references are visually grouped by accreditation group such that it is easy to assimilate the information.

The user may select from the means that are available. Given the available data it will be apparent to any skilled in the art that there are a number of alternative means to visually represent the data and allow the user to interact with it.

Further it will also be apparent that in alternative embodiments where only information source references are returned by the database, or where only accreditation groups are returned by the database the visual representation of the data will be constrained to the available data.

The portable client device thus has access to a positioning subsystem (e.g. a GPS unit) and has a communication link to a Geographic Information Database containing groups of accredited information providers. The database is arranged so as to qualify an information source reference as pertaining to a given location or range of locations: for example defined by distance from a set location or defined as falling within a defined boundary. Information provider groups are stored so as to be accessible by the database. A user of the portable device can transmit information indicative of a query to the database to cause the query to be executed on the database. The definition of the query may include position information indicative of the current location of the portable device. The database may return results from the database consisting in information source references provided by the information providers that are members of the accreditation groups associated with the user and that are associated with the position information.

A range of types of queries can be performed on the database in response to a request from the client device. Examples of such queries are given above.

The user interface of the user's terminal could provide the facility to easily select a geodesic query for execution in order to located references to external data sources of accredited information providers. As indicated above, accreditation is devolved to third party authorities and the user or the operator of the database service could select which third party authorities qualify and constrain the results and thus help to avoid information overload.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A geographic information system for operation with an accreditation database storing identities of information providers and indications of whether each of those information providers is a member of an accreditation group, the system comprising:
a geographic information database for storing a list of information sources external to the database together with, for each source, the identity of an information provider associated with the source and one or more geographic definitions associated with the source;
a search unit for receiving from a user an indication of a geographic location, accessing the geographic information database to form a set of information sources whose geographic definitions encompass that location and which are associated with an information provider that is indicated by the accreditation database as being a member of one or more predetermined accreditation groups, and making that set of information sources available to the user.

2. A geographic information system as claimed in claim 1, wherein the system comprises a user database for storing for each user a set of accreditation groups, and wherein the said predetermined accreditation groups are the accreditation groups stored for the user in the user database.

3. A geographic information system as claimed in claim 1, wherein the accreditation database is a publicly accessible database.

4. A geographic information system as claimed in claim 1, wherein the system comprises an input unit whereby an indicating user may provide an information source and one or more geographic definitions associated with the source for storage in the geographic database.

5. A geographic information system as claimed in claim 4, wherein the input unit is arranged to cause the identity of the said indicating user to be associated with the indicated information source as the identity of the information provider.

6. A geographic information system as claimed in claim 4, wherein the input unit is arranged to limit the capability of an indicating user to provide a geographic definition for storage in the geographic database in dependence on the accreditation groups of which that indicating user is indicated in the accreditation database as being a member.

7. A geographic information system as claimed in claim 6, wherein the input unit is arranged to limit the scope of the geographic definitions that the indicating user may provide for storage in the geographic database in dependence on the accreditation groups of which that indicating user is indicated in the accreditation database as being a member.

8. A geographic information system as claimed in claim 7, wherein the input unit stores a set of predetermined geographic scope limitations each associated with one or more accreditation groups, and is arranged to, if the indicating user is indicated in the accreditation database as being a member of one of those groups, limit the scope of the geographic definitions that the indicating user may provide for storage in the geographic database to the respective limitation.

9. A geographic information system as claimed in claim 6, wherein the input unit is arranged to limit the overlap between geographic definitions that the indicating user may provide for storage in the geographic database and geographic definitions already stored in the database in dependence on the accreditation groups of which that indicating user is indicated in the accreditation database as being a member.

10. A geographic information system as claimed in claim 6, wherein the input unit is arranged to limit the geographic definitions that the indicating user may provide for storage in the geographic database to definitions that are encompassed by geographic definitions already stored in the database in dependence on the accreditation groups of which that indicating user is indicated in the accreditation database as being a member.

11. A geographic information system as claimed in claim 4, wherein the input unit is arranged to limit the capability of an indicating user to provide one or more information sources for storage in the geographic database in dependence on the accreditation groups of which that indicating user is indicated in the accreditation database as being a member.

12. A geographic information system as claimed in claim 11, wherein the input unit is arranged to limit the number of the information sources that the indicating user can provide to the database in dependence on the accreditation groups of which that indicating user is indicated in the accreditation database as being a member.

13. A geographic information system as claimed in claim 1, wherein the search unit is arranged to include in the said set of information sources information sources whose geographic definitions encompass that location which are associated with an information provider specified by the user.

14. A method for providing geographic information to a user, in a system capable of operating with an accreditation database storing identities of information providers and indications of whether each of those information providers is, a member of an accreditation group, the method comprising:
storing in a geographic information database a list of information sources external to the database together with, for each source, the identity of an information provider associated with the source and one or more geographic definitions associated with the source;
receiving from a user an indication of a geographic location;
accessing the geographic information database to form a set of information sources whose geographic definitions encompass that location and associated with an information provider that is indicated by the accreditation database as being a member of one or more predetermined accreditation groups; and
making that set of information sources available to the user.

15. A geographic information system as claimed in claim 2, wherein the accreditation database is a publicly accessible database.

16. A geographic information system as claimed in claim 5, wherein the input unit is arranged to limit the capability of an indicating user to provide a geographic definition for storage in the geographic database in dependence on the accreditation groups of which that indicating user is indicated in the accreditation database as being a member.

17. A geographic information system as claimed in claim 6, wherein the input unit is arranged to limit the capability of an indicating user to provide one or more information sources for storage in the geographic database in dependence on the accreditation groups of which that indicating user is indicated in the accreditation database as being a member.
